(19) United States
(12) Patent Application Publication
(10) Pub. No.: US 2020/0095351 A1
(43) Pub. Date: Mar. 26, 2020

(54) MONOMERS, POLYMERS AND METHODS OF MAKING THE SAME

(71) Applicant: Alliance for Sustainable Energy, LLC, Golden, CO (US)

(72) Inventors: Nicholas A. RORRER, Golden, CO (US); Gregg Tyler BECKHAM, Golden, CO (US); Kelly Marie MEEK, Golden, CO (US)

(21) Appl. No.: 16/583,471

(22) Filed: Sep. 26, 2019

Related U.S. Application Data
(60) Provisional application No. 62/736,798, filed on Sep. 26, 2018.

(51) Int. Cl. C08F 16/10; C08F 16/26; C08F 20/06

(52) U.S. Cl. CPC C08F 16/10; C08F 20/06; C08F 16/26

(57) ABSTRACT

The present disclosure relates to compositions that include at least one of

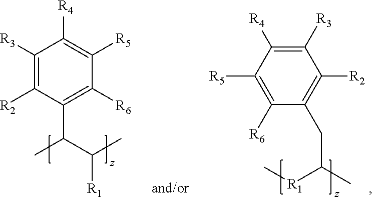

where each of R₁, R₂, R₃, R₄, R₅, and R₆ includes at least one of a carbon atom, a hydrogen atom, an oxygen atom, a nitrogen atom, and/or a halogen atom, each of R₁, R₂, R₃, R₄, R₅, and R₆ may be different or the same, and 1≥z≥50,000.

### CROSS-REFERENCE TO RELATED APPLICATIONS

This application claims the benefit of U.S. Provisional Patent Application No. 62/736,798 filed Sep. 26, 2018, the contents of which are incorporated herein by reference in their entirety.

### CONTRACTUAL ORIGIN

The United States Government has rights in this disclosure under Contract No. DE-AC36-08GO28308 between the United States Department of Energy and Alliance for Sustainable Energy, LLC, the Manager and Operator of the National Renewable Energy Laboratory.

### BACKGROUND

Acrylonitrile-butadiene-styrene, or ABS, is a thermoplastic polymer typically used in injection molding and extruding applications. Styrene and acrylonitrile can be polymerized in the presence of polybutadiene, to create lightweight materials having superior hardness, toughness and resistance properties. ABS is commonly used for ventilation pipes, automotive components, kitchen appliances, and even Lego bricks. One of the major drawbacks of this ubiquitous material is that it is made from petroleum-derived chemicals. Therefore, the development of monomers having properties similar to styrene, from lignocellulosic biomass, is of high interest for yielding a fully renewable thermoplastic materials, including materials having properties similar to ABS.

### SUMMARY

An aspect of the present disclosure is a composition that includes at least one of

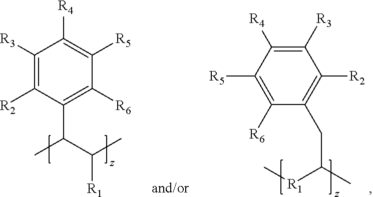

where each of R₁, R₂, R₃, R₄, R₅, and R₆ includes at least one of a carbon atom, a hydrogen atom, an oxygen atom, a nitrogen atom, and/or a halogen atom, each of R₁, R₂, R₃, R₄, R₅, and R₆ may be different or the same, and 1≥z≥50,000. In some embodiments of the present disclosure, each of R₁, R₂, R₃, R₄, R₅, and R₆ may include at least one of a hydroxyl group, an alkyl group, an alkoxy group, a carboxylic acid, and/or an ether.

In some embodiments of the present disclosure, the composition may be derived from a monomer comprising at least one of

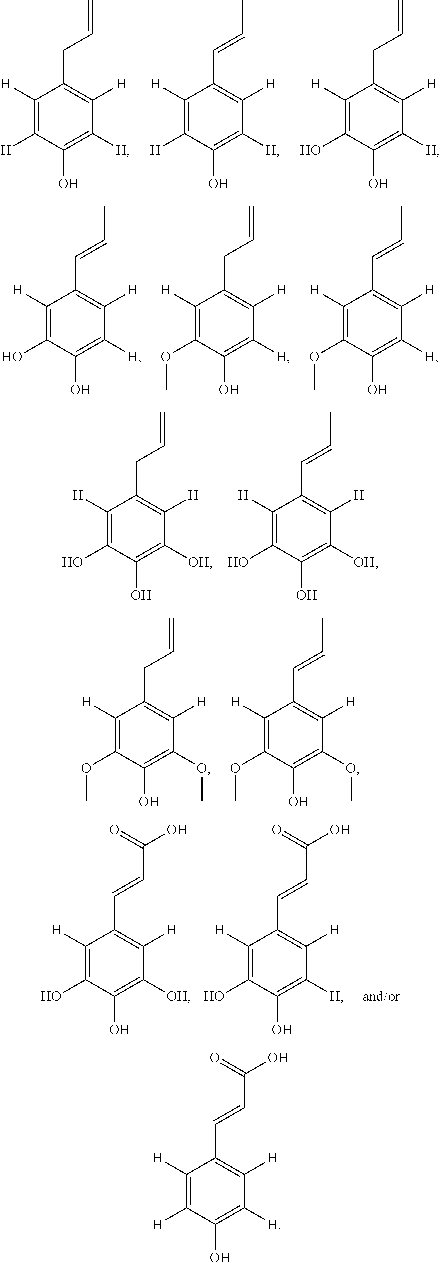

In some embodiments of the present disclosure, the composition may include at least one of

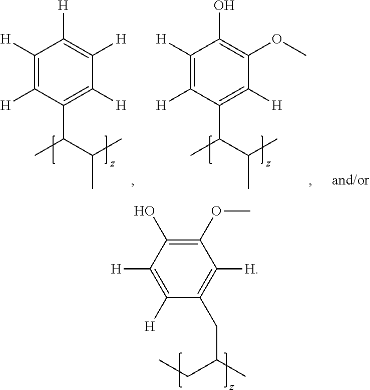

In some embodiments of the present disclosure, the composition may further include a repeat unit, A, resulting in

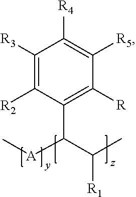

where A may include at least one of a carbon atom, a hydrogen atom, an oxygen atom, and/or a nitrogen atom, and 1≥y≥50,000.

In some embodiments of the present disclosure, the composition may include at least one of

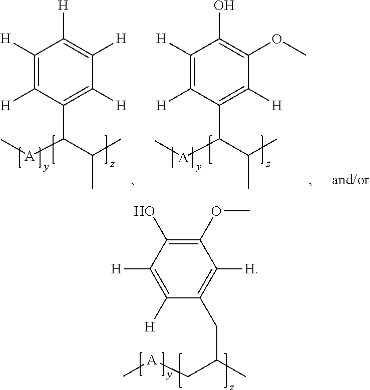

In some embodiments of the present disclosure, the composition may include at least one of

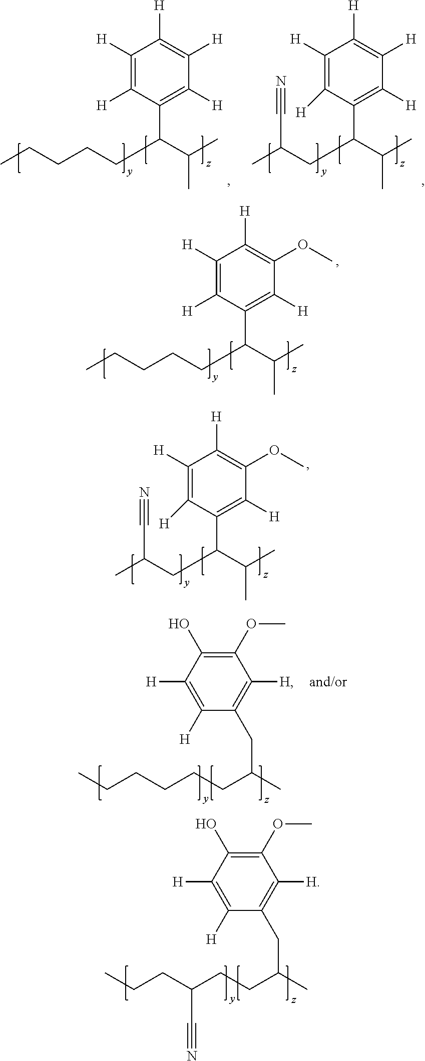

In some embodiments of the present disclosure, the composition may include at least one of

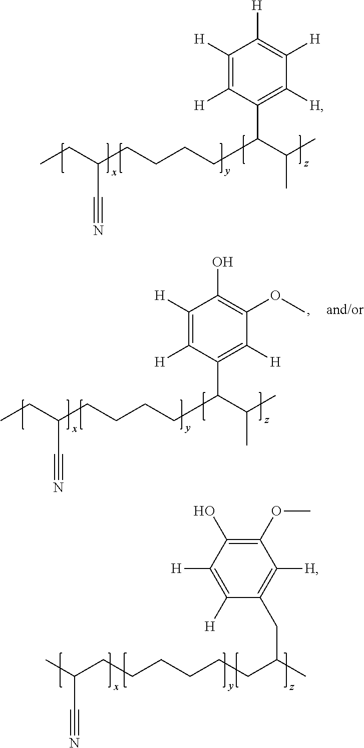

where 1≥x≥50,000.

In some embodiments of the present disclosure, the composition may further include a storage modulus between greater than about 100 GPa and less than about 1000 GPa. In some embodiments of the present disclosure, the composition may further include a loss modulus between greater than about 10 Pa and less than about 110 Pa. In some embodiments of the present disclosure, the composition may further include a glass transition temperature between greater than about 100° C. and less than about 130° C. In some embodiments of the present disclosure, the composition may be at least partially bioderived.

An aspect of the present disclosure is a method of making a polymer, where the method includes recovering a monomer from a lignin-containing material and reacting the monomer to produce a polymer that includes at least one of

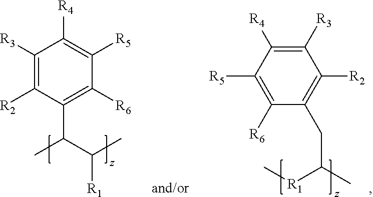

where each of R₁, R₂, R₃, R₄, R₅, and R₆ includes at least one of a carbon atom, a hydrogen atom, an oxygen atom, a nitrogen atom, and/or a halogen atom, each of R₁, R₂, R₃, R₄, R₅, and R₆ may be different or the same, and 1≥z≥50,000.

An aspect of the present disclosure is a composition that includes at least one of

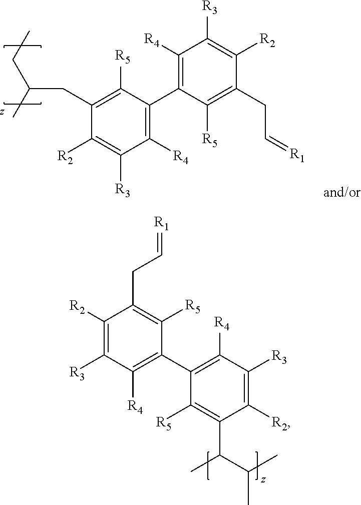

where each of R₁, R₂, R₃, R₄, and R₅ includes at least one of a carbon atom, a hydrogen atom, an oxygen atom, a nitrogen atom, and/or a halogen atom, each of R₁, R₂, R₃, R₄, and R₅ may be different or the same, and 1≥z≥50,000.

In some embodiments of the present disclosure, the composition may be derived from a dimer that includes at least one of

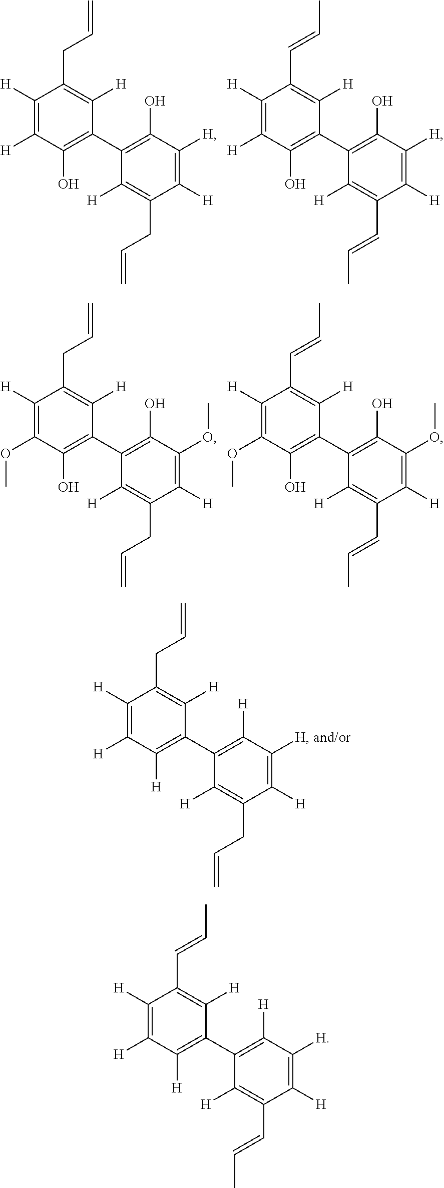

In some embodiments of the present disclosure, the composition may include at least one of

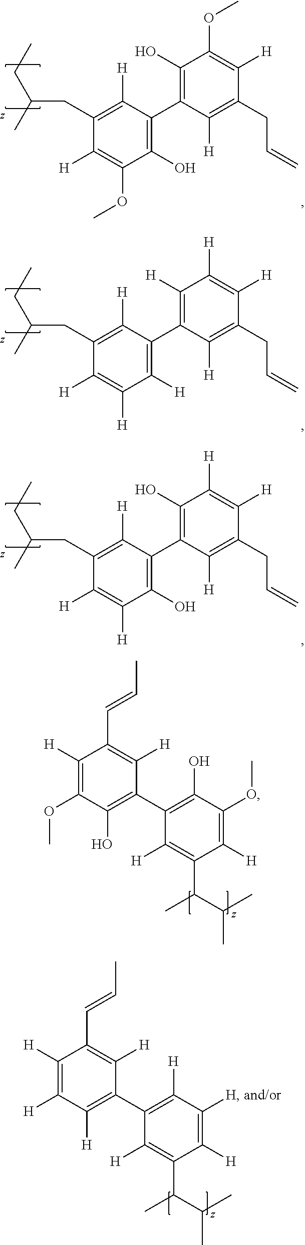

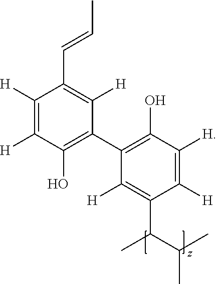

In some embodiments of the present disclosure, the composition may be at least partially bioderived.

An aspect of the present disclosure is a composition that includes at least one of

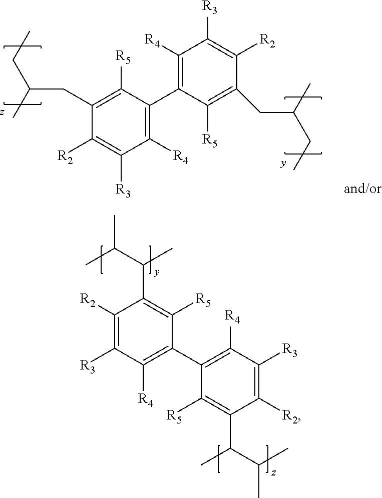

where each of R₂, R₃, R₄, and R₅ includes at least one of a carbon atom, a hydrogen atom, an oxygen atom, a nitrogen atom, and/or a halogen atom, each of R₁, R₂, R₃, R₄, and R₅ may be different or the same, 1≥z≥50,000, and 1≥y≥50,000.

In some embodiments of the present disclosure, the composition may be derived from a dimer that includes at least one of

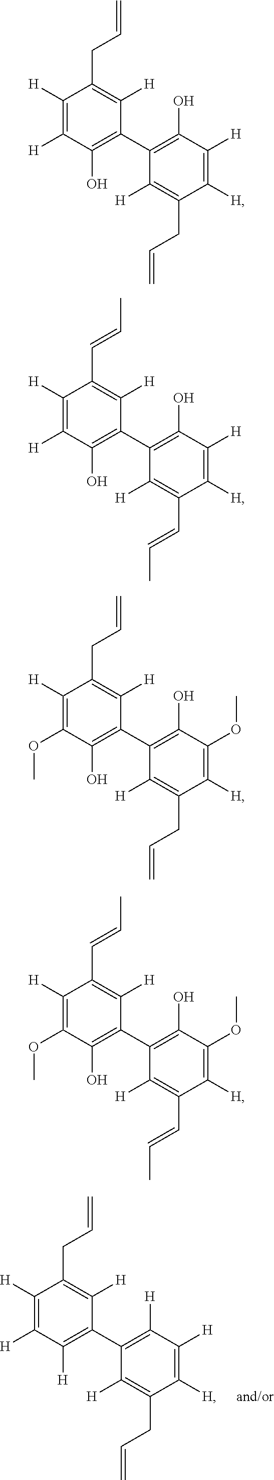

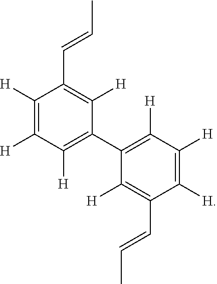

In some embodiments of the present disclosure, the composition may include at least one of

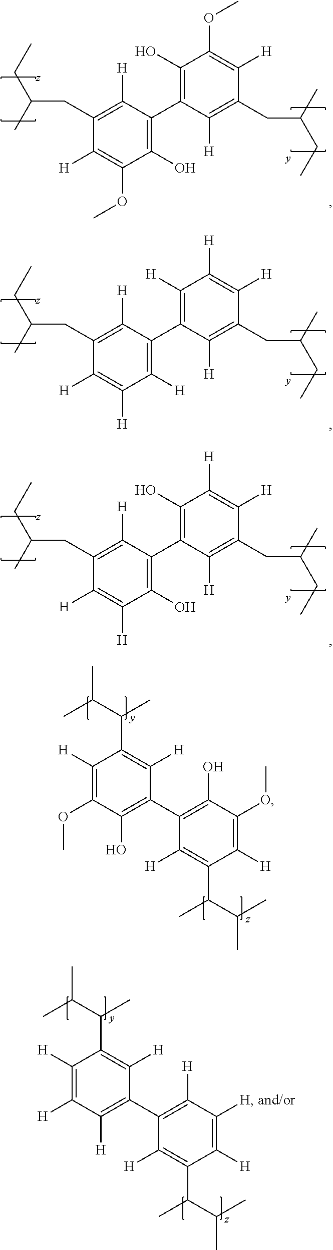

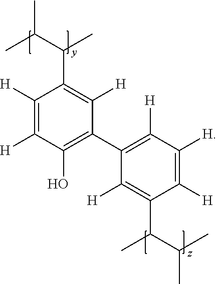

### BRIEF DESCRIPTION OF THE DRAWINGS

FIG. 1A illustrates storage modulus and loss modulus measurements evaluated by dynamic mechanical analysis (DMA), according to some embodiments of the present disclosure.

FIG. 1B illustrates glass transition temperatures (T_{g}s) evaluated by differential scanning calorimetry (DSC) and polymerization yields for ABS and ABS-alternatives synthesized by cationic, free radical, and RAFT polymerization, according to some embodiments of the present disclosure.

### DETAILED DESCRIPTION

References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The present disclosure relates to, among other things, the polymerization of novel monomers to produce novel polymers having properties equal to or similar to acrylonitrile-butadiene-styrene (ABS) polymers, polymers made by the polymerization of acrylonitrile, butadiene, and styrene. In some embodiments of the present disclosure, the monomers may be bioderived and/or derived from waste materials; e.g. municipal waste. For example, at least a portion of the carbon present in at least one monomer and/or polymer may be bioderived, where the portion of bioderived carbon may be determined according to ASTM D866. In some embodiments of the present disclosure, a bioderived monomer may be derived from biomass. In some embodiments of the present disclosure, biomass used to produce the monomers and polymers described herein, may include at least one of lignin, cellulose, and/or hemicellulose, such that the biomass originates from at least one of bioenergy crops, agricultural residues, municipal solid waste, industrial solid waste, sludge from paper manufacture, yard waste, wood and forestry waste. More specific examples of biomass include, but are not limited to, grain, corn cobs, crop residues such as corn husks, corn stover, corn fiber, grasses, wheat, wheat straw, barley, barley straw, hay, rice straw, switchgrass, waste paper, sugar cane bagasse, sorghum, soy, components obtained from milling of grains, trees, branches, roots, leaves, wood (e.g., poplar) chips, sawdust, shrubs and bushes, vegetables, fruits, flowers, and/or animal manure.

In some embodiments of the present disclosure, biomass and/or waste materials may be deconstructed (also referred to as depolymerization) by at least one of thermal, chemical, and/or mechanical means. Methods that may be used to deconstruct biomass and/or waste materials include gasification, pyrolysis, acid and/or base treatments, and/or metabolism by microorganisms. Any one of these methods may deconstruct, among other things, at least a portion of the lignin contained within the biomass, resulting in a variety of monomers, dimers, trimers, oligomers, and/or larger molecular weight compounds. Such a mix of lignin decomposition products may be separated into smaller groups of molecules and/or individual compounds using suitable separation methods, for example, extraction methods, crystallization methods, distillation methods, filtration methods, and/or gravimetric methods. As described herein, lignin-derived monomers that include the structure of a benzene ring and a functional group having a carbon-carbon double-bond (other than styrene) may be utilized as bioderived styrene replacement molecules to make copolymers. For example, a bioderived, functionalized benzene molecule may be reacted with acrylonitrile and butadiene to produce a bioderived polymer having physical properties and performance characteristics similar to acrylonitrile-butadiene-styrene (ABS).

Generalized structures for bioderived monomers, according to some embodiments of the present disclosure, are shown below in Structures 1 and 2,

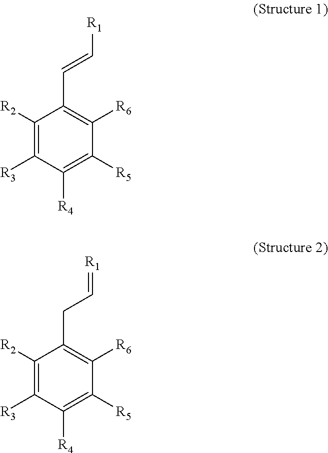

where each of R₁, R₂, R₃, R₄, R₅, and R₆ may include at least one of a carbon atom, a hydrogen atom, an oxygen atom, a nitrogen atom, a sulfur atom, and/or a halogen atom. In some embodiments of the present disclosure, each one of R₁, R₂, R₃, R₄, R₅, and R₆ may include at least one of a hydroxyl group (e.g. —OH, —CH₂—OH, —CH₂CH₂—OH, —CH₂CH₂CH₂—OH, etc.), an alkyl group (e.g. methyl, butyl, propyl, etc.), an alkoxy group (e.g. methoxy), a carboxylic acid, a propyl carboxylic acid, an ether, a cyclic ether, and/or an alkyl ether. When R₁ is a methyl group and R₂, R₃, R₄, R₅, and R₆ are each hydrogen atoms, the resulting bioderived monomer is trans-β-methylstyrene (tβMS), shown in Structure 3 below.

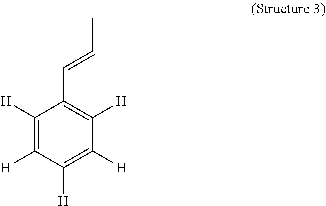

Referring again to Structure 1, when R₁ is a methyl group, R₂, R₅, and R₆ are each hydrogen atoms, R₃ is a methoxy group, and R₄ a hydroxyl group, the resulting bioderived monomer is isoeugenol, shown in Structure 4 below.

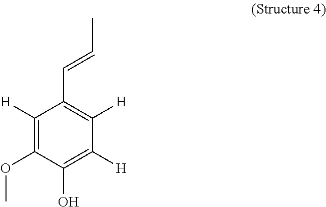

Referring to Structure 2, when R₁ is a methyl group, R₂, R₅, and R₆ are each hydrogen atoms, R₃ is a methoxy group, and R₄ a hydroxyl group, the resulting bioderived monomer is eugenol, shown in Structure 5 below.

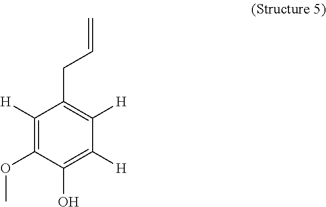

Other bioderived monomers that may be used as styrenic replacement monomers in polymers, according to some embodiments of the present disclosure, may include at least one of

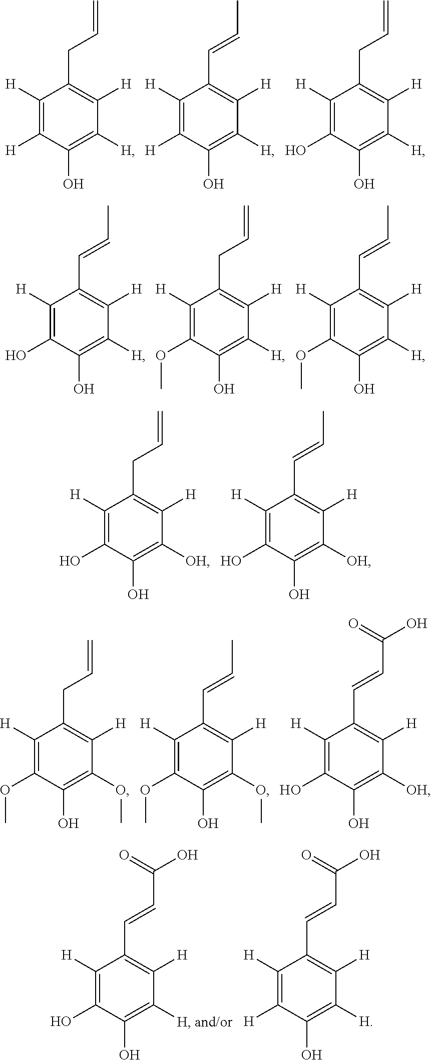

According to some embodiments of the present disclosure, Structure 1 above may be polymerized, resulting in the polymer illustrated in Structure 6 below,

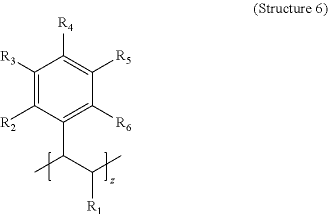

where z may be between 1 and 50,000 or between 2 and 10,000.

According to some embodiments of the present disclosure, Structure 2 above may be polymerized, resulting in the polymer illustrated in Structure 7 below,

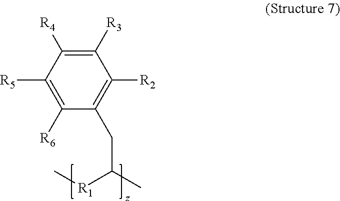

where z may be between 1 and 50,000 or between 2 and 10,000.

According to some embodiments of the present disclosure, Structure 3 (tβMS) above may be polymerized, resulting in the polymer illustrated in Structure 8 below,

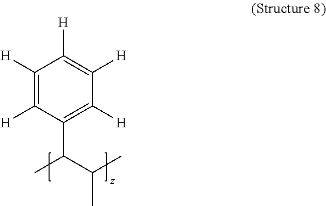

where z may be between 1 and 50,000 or between 2 and 10,000.

According to some embodiments of the present disclosure, Structure 4 (isoeugenol) above may be polymerized, resulting in the polymer illustrated in Structure 9 below,

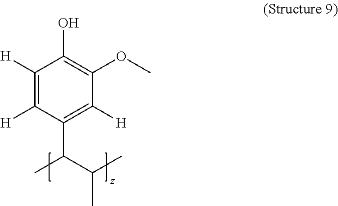

where z may be between 1 and 50,000 or between 2 and 10,000.

According to some embodiments of the present disclosure, Structure 5 (eugenol) above may be polymerized, resulting in the polymer illustrated in Structure 10 below,

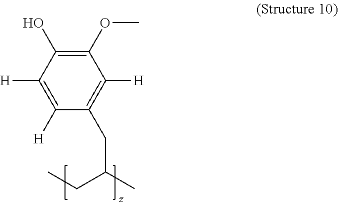

where z may be between 1 and 50,000 or between 2 and 10,000.

Thus, the present disclosure relates to multiple styrene-like, lignin-derived monomers that can be obtained from reductive catalytic fractionation (RCF) and/or hydrodeoxygenation (HDO) of lignin, such that the monomers may function as styrene replacement monomers and/or used in conjunction with styrene, with exemplary lignin-derived monomers including trans-β-methylstyrene (tβMS), eugenol (E), and isoeugenol (I). These monomers may in turn be polymerized to produce at least partially bioderived polymers as shown above (Structures 6-10). In addition, any one of the monomers illustrated above (Structures 1-5) may be copolymerized with at least one other monomer to produce polymers constructed of the two or more monomers. For example, the monomer of Structure 1 above may be polymerized with at least one additional monomer resulting in a second repeat unit, A, further resulting in the polymer shown below as Structure 11,

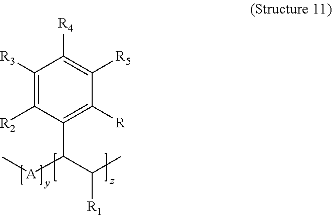

where y and z may each be between 1 and 50,000 or between 2 and 10,000. Similarly, Structure 2 above may be polymerized with at least one additional monomer resulting in a second repeat unit, A, further resulting in the polymer shown below as Structure 12,

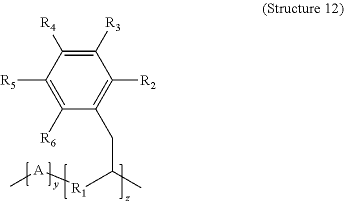

where y and z may each be between 1 and 50,000.

In some embodiments of the present disclosure, tβMS may be copolymerized with some other monomer, resulting in a second repeat unit, A, to yield a polymer like that shown in Structure 13, where y and z may each be between 1 and 50,000 or between 2 and 10,000:

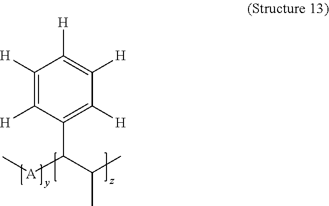

In some embodiments of the present disclosure, isoeugenol may be copolymerized with some other monomer, resulting in a second repeat unit A, to yield a polymer like that shown in Structure 14, where y and z may each be between 1 and 50,000 or between 2 and 10,000:

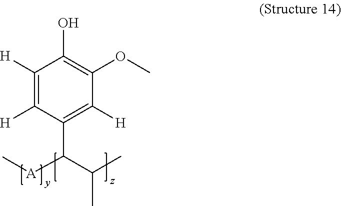

In some embodiments of the present disclosure, eugenol may be copolymerized with some other monomer, resulting in a second repeat unit, A, to yield a polymer like that shown in Structure 15, where y and z may each be between 1 and 50,000 or between 2 and 10,000:

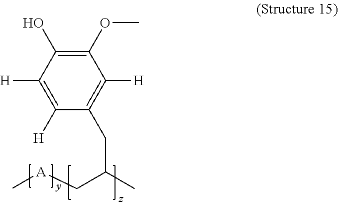

In some embodiments of the present disclosure, a repeat unit, A, may be derived from at least one of butadiene, acrylonitrile, polyisoprene, polybutadiene, isoprene, a natural rubber, an alkenes, muconate, acrylic acid, methacrylic acid, an acrylate, a vinyl nitrile, and/or a vinyl polymer. For example, copolymerization of at least one of tβMS, isoeugenol, and/or eugenol with at least one of butadiene and/or acrylonitrile may yield at least one of the following polymers,

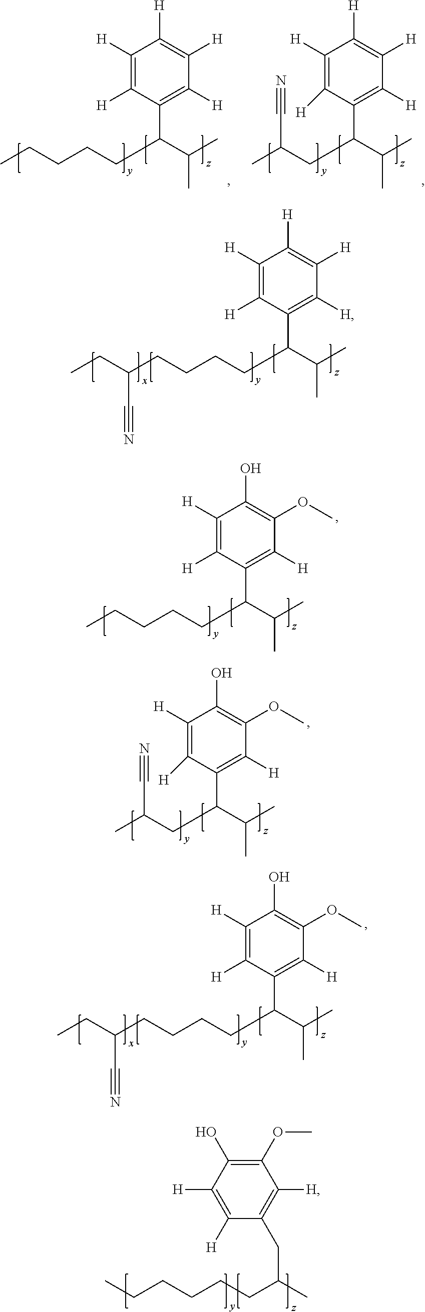

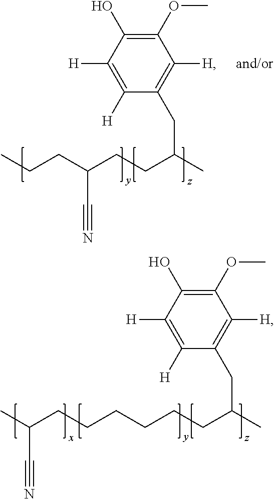

wherein x, y, and z may each be between 0 and 50,000 or between 2 and 10,000. In some embodiments of the present disclosure, one or more of any of the monomers illustrated above may be used to synthesize polymers having one or more repeat units. Thus, in some embodiments of the present disclosure, a composition may be constructed of at least one repeat unit, two repeat units, three repeat units, or more than three repeat units.

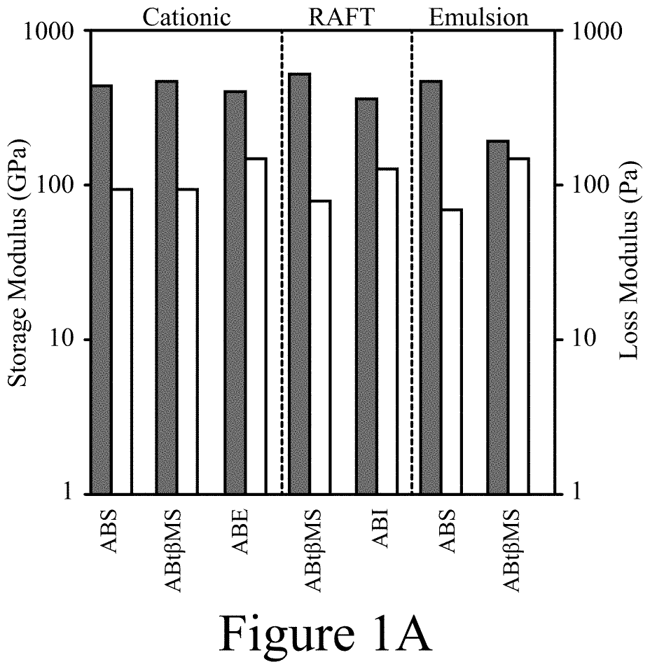

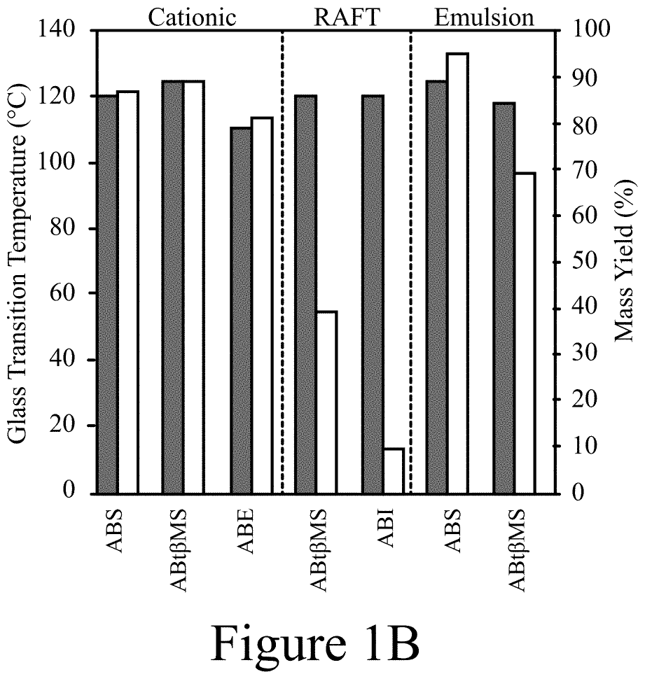

Industrially, ABS is most commonly synthesized by free radical emulsion polymerization. As described herein, multiple polymerization techniques were used (emulsion, cationic, reversible addition-fragmentation chain-transfer (RAFT)) to produce bioderived ABS alternatives and to optimize the yield and incorporation of the bioderived alternative styrenic components into the end-products. Mechanical properties (storage modulus and loss modulus) and thermal properties (glass transition temperature) of the resultant bioderived polymers were investigated relative to ABS synthesized under the same reaction conditions (see FIGS. 1A and 1B). FIG. 1A illustrates storage modulus and loss modulus measurements evaluated by dynamic mechanical analysis (DMA). FIG. 1B illustrates glass transition temperatures (T_{g}s) evaluated by differential scanning calorimetry (DSC) and polymerization yields for ABS and ABS-alternatives synthesized by cationic, free radical, and RAFT polymerization.

In summary, the synthetic method used to produce the polymers made a significant difference in the mechanical properties of the polymers. Cationic polymerization of butadiene and acrylonitrile with styrene replacement monomers produced polymers having properties comparable to ABS; storage moduli of ABtβMS and ABE polymers were within 7% of the modulus of ABS. Greater discrepancies were noted in the copolymers synthesized by other methods. Overall, ABS-like polymers, ABtβMS and ABI, synthesized by RAFT had the highest storage modulus with the lowest loss modulus, while ABtβMS synthesized by emulsion polymerization had the lowest storage modulus with the highest loss modulus. Glass transition temperatures (T_{g}) of all materials ranged from 110° C. to 125° C. and fell within the range of industrial applications, as ABS typically has a T_{g} of between 80° C. and 125° C., depending on the material grade. Not all styrene-alternative monomers were reactive by all methods; ABE was only reactive in appreciable yields via cationic polymerization, while ABI was only reactive in appreciable yields via RAFT. Significantly higher product yields were obtained via cationic vs. RAFT or emulsion polymerization.

In summary, three styrene-alternative, lignin-derived monomers that are obtainable from RCF or HDO of lignin were evaluated via three polymerization techniques as functional replacements for styrene in ABS. Of these alternative monomers and methods, trans-β-methylstyrene reacted by cationic polymerization to produce ABtβMS gave the most promising results. ABtβMS from cationic polymerization had a T_{g} within 5° C. of ABS, a higher product yield than ABS, the same loss modulus, and an improved storage modulus. With improved mechanical properties and product yield, ABtβMS is suitable to be not only a functional replacement for ABS, but also a performance-advantaged bioderived replacement.

Using radiocarbon and isotope ratio mass spectrometry analysis, the bioderived content of materials can be determined. ASTM International, formally known as the American Society for Testing and Materials, has established a standard method for assessing the biobased content of carbon-containing materials. The ASTM method is designated ASTM-D6866. The application of ASTM-D6866 to derive a “biobased content” is built on the same concepts as radiocarbon dating, but without use of the age equations. The analysis is performed by deriving a ratio of the amount of radiocarbon (14C) in an unknown sample to that of a modern reference standard. The ratio is reported as a percentage with the units “pMC” (percent modern carbon). If the material being analyzed is a mixture of present-day radiocarbon and fossil carbon (containing no radiocarbon), then the pNMC value obtained correlates directly to the amount of biomass material present in the sample. Thus, ASTM-D866 may be used to validate that the compositions described herein are and/or are not derived from renewable sources.

Thus, in general the present disclosure relates to monomers and polymers, where in some embodiments the polymer includes a first repeat unit derived from a nitrile (e.g. acrylonitrile), a second repeat unit derived from a diene (e.g. butadiene), and a third repeat unit derived from a monomer comprising a benzene ring and an organic chain having a carbon-carbon double, where the monomer is not styrene. In some cases, the third repeat unit may be derived from at least one of trans-β-methylstyrene, eugenol, and/or isoeugenol. In some embodiments of the present disclosure, a polymer may include at least one third repeat unit selected from the embodiments illustrated above. In addition, in some embodiments of the present disclosure, a repeat unit used to synthesize bioderived polymers may include a dimer having the structure of Structure 16 or Structure 17:

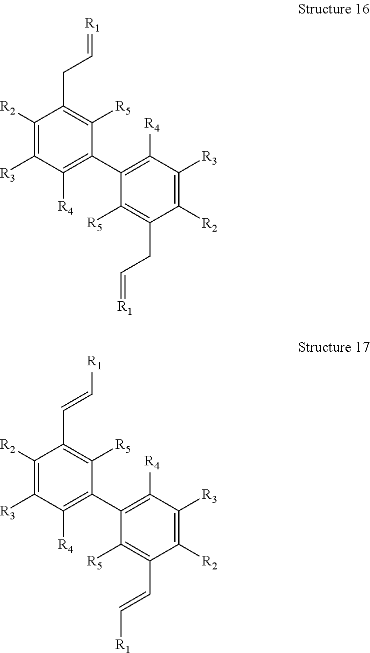

where each of R₁, R₂, R₃, R₄, and R₅ may include at least one of a carbon atom, a hydrogen atom, an oxygen atom, a nitrogen atom, and/or a halogen atom. Although Structures 16 and 17 both show the carbon-carbon double-bounds in the same positions relative to R₁, dimers having a first carbon-carbon double-bound adjacent to R₁ and a second carbon-carbon double-bond in the iso-position relative to R₁ are within the scope of the present disclosure. In some embodiments of the present disclosure, each one of R₁, R₂, R₃, R₄, and R₅ may include at least one of a hydroxyl group (e.g. —OH, —CH₂—OH, —CH₂CH₂—OH, —CH₂CH₂CH₂—OH, etc.), an alkyl group (e.g. methyl, butyl, propyl, etc.), an alkoxy group (e.g. methoxy), a carboxylic acid, a propyl carboxylic acid, an ether, a cyclic ether, and/or an alkyl ether. Specific examples of such dimers, which fall within the scope of the present disclosure, include at least one of

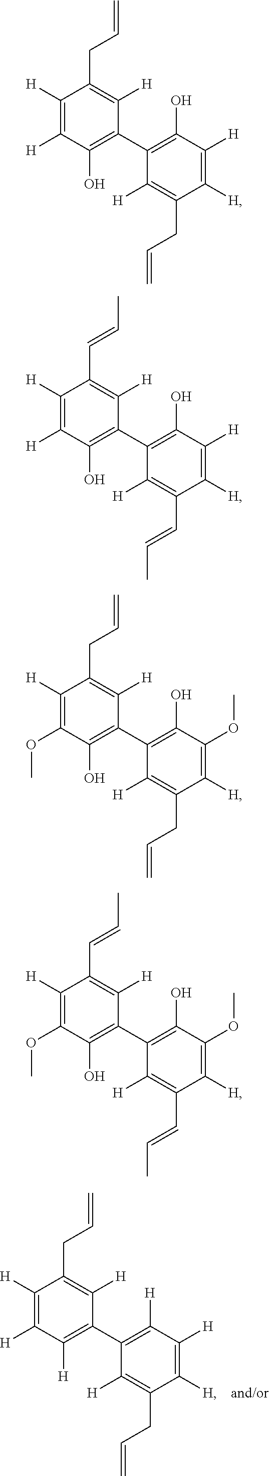

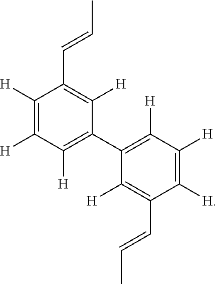

One or more of the dimers shown above may be reacted to make an at least partially bioderived polymer and/or resin. For example, Structure 16 may be reacted to produce a polymer having the structure,

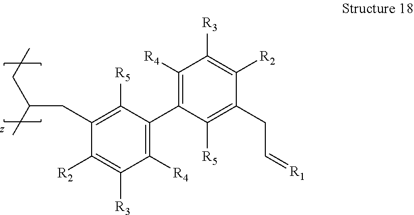

where z may be between 1 and 50,000 or 2 and 10,000, and/or Structure 16 may be reacted to product a resin having the structure,

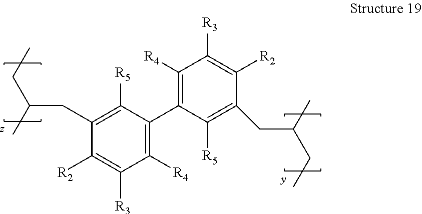

where y and z may be between 1 and 50,000 or 2 and 10,000.

In some embodiments of the present disclosure, Structure 17 may be reacted to produce a polymer having the structure,

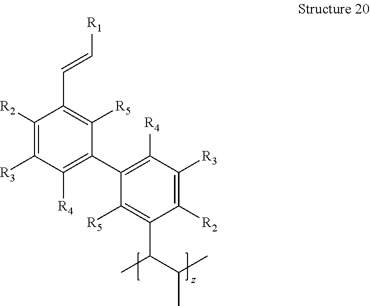

where z may be between 1 and 50,000 or 2 and 10,000, and/or Structure 17 may be reacted to product a resin having the structure,

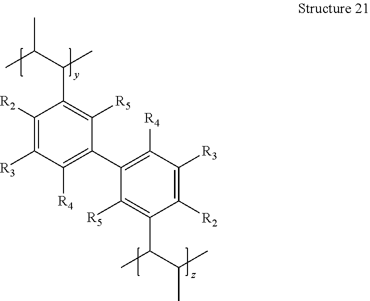

Thus, specific examples of polymers that may result from the dimers shown in Structures 16 and 17 include at least one of,

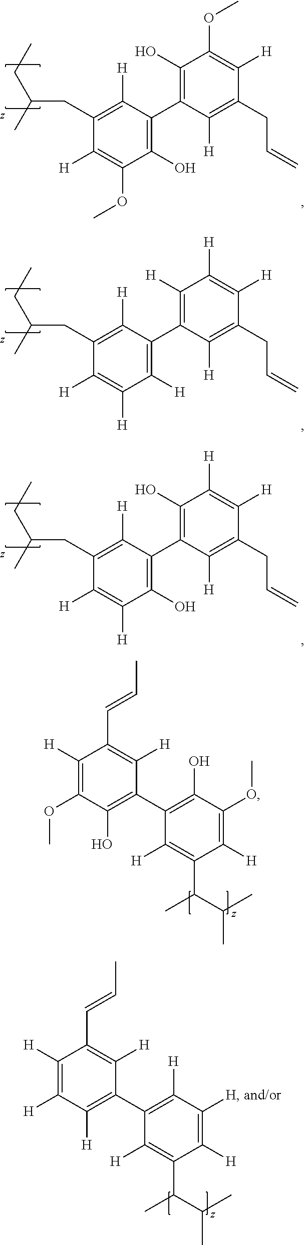

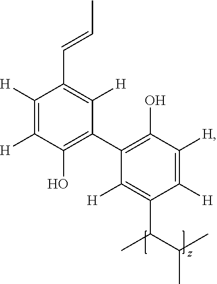

and/or z, where z may be between 1 and 50,000 or 2 and 10,000.

Thus, specific examples of resins that may result from the dimers shown in Structures 16 and 17 include at least one of,

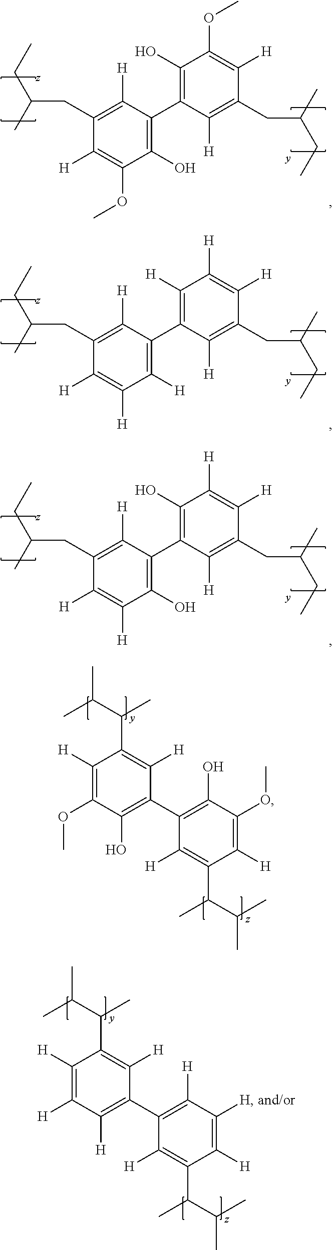

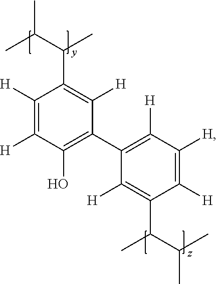

where y and z are each between 1 and 50,000 or 2 and 10,000.

### Materials and Methods:

Materials. Polybutadiene (ave. Mn˜5000), azobisisobutyronitrile (AIBN, 98%), 1,1,1,3,3,3-hexafluoro-2-propanol (HFIP, ≥99%), 2-cyano-2-propyl dodecyl trithiocarbonate (CPDT, 97%), were used as received from Sigma-Aldrich. Styrene (ReagentPlus®, contains 4-tert-butylcatechol as stabilizer, ≥99%) and acrylonitrile (≥99%, contains 35-45 ppm monomethyl ether hydroquinone as inhibitor) were obtained from Sigma-Aldrich and passed through inhibitor removal columns packed with Al₂O₃.

Cationic Polymerization of ABS. In the case of cationic polymerization 5*10⁻³ mols (0.25 mol %, with a suitable range being between 0.0001 mol % and 5 mol % based on reactants only; excluding the solvent) of BF₃OEt₂ in acetonitrile was used as an initiating agent (other suitable initiating agents include a carbonium ion, a carbenium ion, a protic acid, boron trifluoride, as well as ionizing radiation) and added to a solution (typically in a suitable halogenated solvent such as dichloromethane or dichlorobenzene) containing 2 mols (99 mol % with a suitable range between 85 mol % and 99.9 mol %) of polybutadiene, styrene (or styrene-alternative), acrylonitrile in a weight ratio of 1:2:1 and 0.02 mols (0.75 mol % with a suitable range being between 0.0001 mol % and 15 mol %) of 1-(4-methoxyphenol)-ethanol. The reaction was allowed to proceed for 48 hours (with a suitable range being between 0.5 hours to 1 week) at ambient temperatures (with a suitable range being between −80° C. to 200° C.). Following polymerization methanol (with other options including water and/or some other alcohol) was added to the solution to terminate polymerization and precipitate the polymer with was subsequently filtered, and dried under vacuum in an oven at 40° C. for 24 hours. In general, the ratio of styrene/styrene-replacement to acrylonitrile and butadiene may be defined by 0<x<1-y-z, 0<y<1-x-z, and 0<z<1-z-y, where x is the amount of styrene/styrene-replacement monomer, y is the amount of acrylonitrile, and z is the amount of butadiene (on a mass basis). In some embodiments of the present disclosure, the amount of styrene/styrene-replacement monomer present in a reaction, x, may be between zero and 0.6, the amount of butadiene present, z, may be between zero and 0.50, and the amount of acrylonitrile, y, may be between zero and 0.5. This applies regardless of the method used for polymerizing; e.g. cationic, RAFT, or emulsion polymerization.

RAFT Polymerization of ABS and ABS-alternatives. A typical polymerization was as follows: polybutadiene, styrene (or styrene-alternative), acrylonitrile, and HFIP were combined in a 20 mL vessel at a mass ratio of 2:1:1:2. The initiator, AIBN, (or any free radical initiator acceptable for the solvent including persulfates, peroxides, or azo components) and the chain transfer agent, CPDT, were added to the mixture at a molar ratio of 0.01 mol and 0.02 mol relative to 1 mol styrene (or styrene-alternative), respectively. The solution was purged with nitrogen, capped, and stirred at 60° C. (with a suitable temperature between 0° C. and the solvent boiling point) in a heating block for 168 hours (with suitable reaction times being between 30 minutes and one week). The resulting polymer was precipitated into methanol, filtered, and dried under vacuum in an oven at 40° C. for 24 hours.

Free Radical Polymerization of ABS. All ABS samples were prepared using the same initial weight loading of butadiene to styrene to acrylonitrile at a mass ratio of 1:2:1. Free radical synthesis was initially attempted using a solution polymerization of 5 g of the initial ABS mixture into 50 g of 10 wt. % polyvinyl alcohol in water solution (or any other acceptable solvent or emulsion system) with 0.05 g of ammonium persulfate as an initiator (or any other free radical initiator for the solvent system including persulfates, peroxides, or azo components. The mixture was heated to 80° C. (with a suitable temperature being between room temperature with UV light up to the solvent boiling point) and allowed to stir for 24 hours under reflux (with a suitable time being between 5 minutes to one week). Following the 24-hour period, the polymer had begun to precipitate out and the reaction mixture was further diluted to cause the remaining polymer to crash out of solution.

Mechanical Characterization. Mechanical behavior of the polymers was tested by dynamic mechanical analysis (DMA; TA Instruments, Q5000). A rectangular sample with dimensions of 35×5×2 mm was tested at 35° C. using the three-point bend geometry fixture with a frequency sweep from 0.01 Hz to 1 Hz. Storage and loss moduli were recorded and reported in FIG. 1 at 1 Hz.

Thermal Characterization. Thermal behavior of the polymers was observed by differential scanning calorimetry (DSC; TA Instruments, Q2000) over a temperature range of 0 to 200° C. at a heating/cooling rate of 10° C./min under a N₂ environment using a heat/cool/heat method. Glass transition temperatures (T_{g}) are reported in FIG. 1.

### EXAMPLES

### Example 1

A composition comprising: at least one of

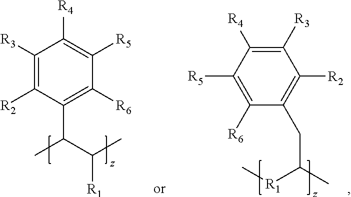

wherein: each of R₁, R₂, R₃, R₄, R₅, and R₆ comprises at least one of a carbon atom, a hydrogen atom, an oxygen atom, a nitrogen atom, or a halogen atom, each of R₁, R₂, R₃, R₄, R₅, and R₆ may be different or the same, and 1≥z≥50,000.

### Example 2

The composition of Example 1, wherein each of R₁, R₂, R₃, R₄, R₅, and R₆ comprises at least one of a hydroxyl group, an alkyl group, an alkoxy group, a carboxylic acid, or an ether.

### Example 3

The composition of Example 1, wherein the composition is derived from a monomer comprising at least one of

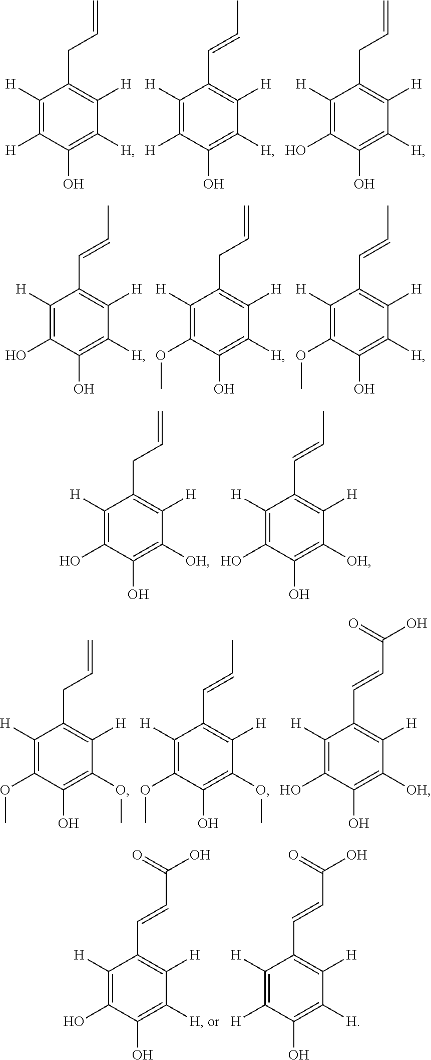

### Example 4

The composition of Example 1, comprising at least one of

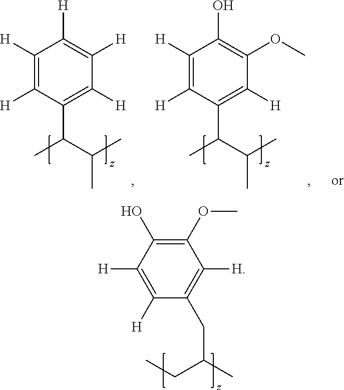

### Example 5

The composition of Example 1, further comprising a repeat unit, A, resulting in

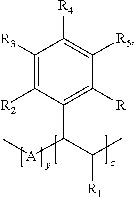

wherein A comprises at least one of a carbon atom, a hydrogen atom, an oxygen atom, or a nitrogen atom, and 1≥y≥50,000.

### Example 6

The composition of Example 5, comprising at least one of

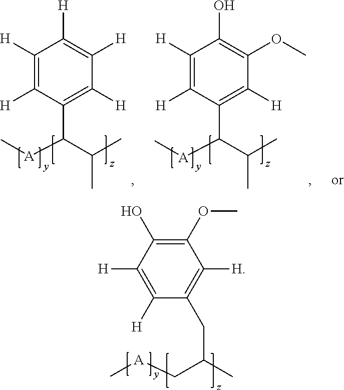

### Example 7

The composition of 6, comprising at least one of

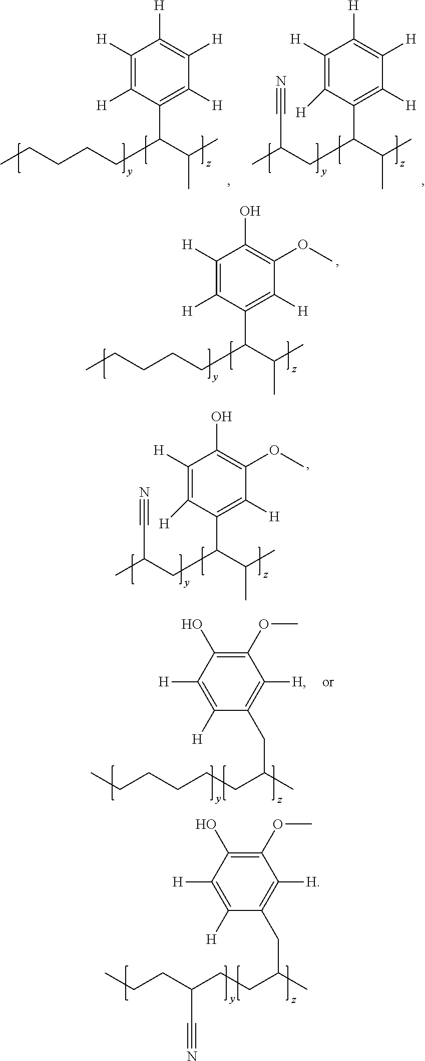

### Example 8

The composition of Example 7, further comprising at least one of

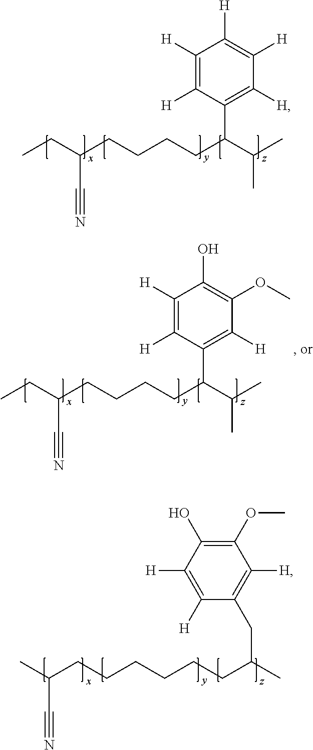

wherein 1≥x≥50,000.

### Example 9

The composition of Example 8, further comprising a storage modulus between greater than about 100 GPa and less than about 1000 GPa.

### Example 10

The composition of Example 8, further comprising a loss modulus between greater than about 10 Pa and less than about 110 Pa.

### Example 11

The composition of Example 8, further comprising a glass transition temperature between greater than about 100° C. and less than about 130° C.

### Example 12

The composition of Example 1, wherein the composition is at least partially bioderived.

### Example 13

A method of making a polymer, the method comprising: recovering a monomer from a lignin-containing material; and reacting the monomer to produce a polymer comprising:

at least one of

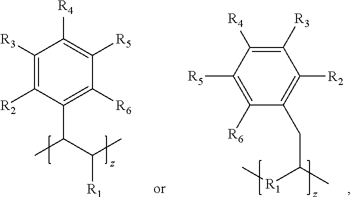

wherein: each of R₁, R₂, R₃, R₄, R₅, and R₆ comprises at least one of a carbon atom, a hydrogen atom, an oxygen atom, a nitrogen atom, or a halogen atom, each of R₁, R₂, R₃, R₄, R₅, and R₆ may be different or the same, and 1≥z≥50,000.

### Example 14

The method of Example 13, wherein each of R₁, R₂, R₃, R₄, R₅, and R₆ comprises at least one of a hydroxyl group, an alkyl group, an alkoxy group, a carboxylic acid, or an ether.

### Example 15

A composition comprising: at least one of

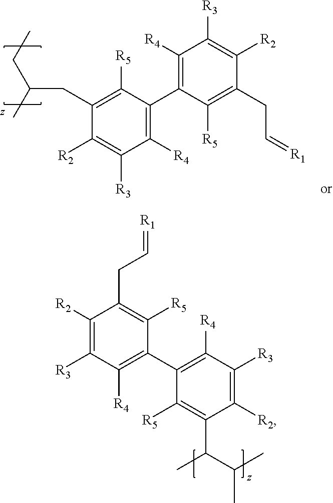

wherein:

each of R₁, R₂, R₃, R₄, and R₅ comprises at least one of a carbon atom, a hydrogen atom, an oxygen atom, a nitrogen atom, or a halogen atom, each of R₁, R₂, R₃, R₄, and R₅ may be different or the same, and 1≥z≥50,000.

### Example 16

The composition of Example 15, wherein each of R₁, R₂, R₃, R₄, and R₅ comprises at least one of a hydroxyl group, an alkyl group, an alkoxy group, a carboxylic acid, or an ether.

### Example 17

The composition of Example 15, wherein the composition is derived from a dimer comprising at least one of

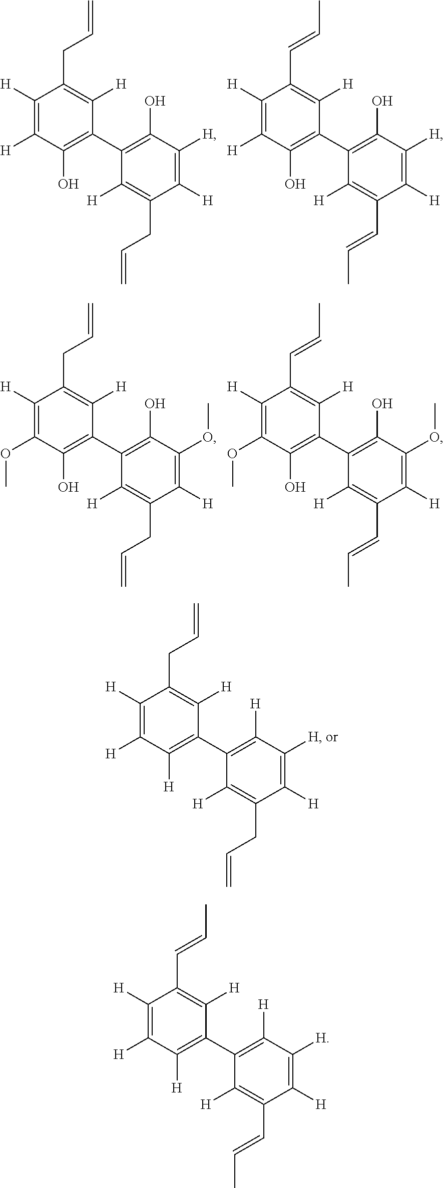

### Example 19

The composition of Example 15, comprising at least one of

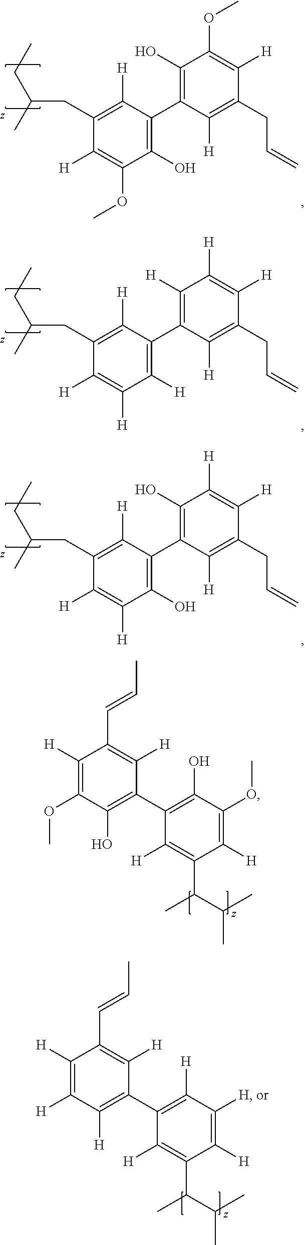

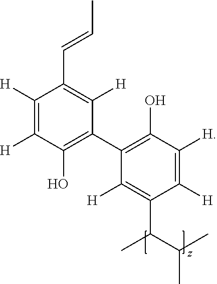

### Example 20

The composition of Example 15, wherein the composition is at least partially bioderived.

### Example 21

A composition comprising: at least one of

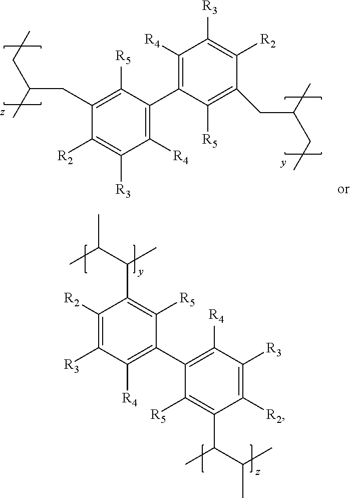

wherein: each of R₂, R₃, R₄, and R₅ comprises at least one of a carbon atom, a hydrogen atom, an oxygen atom, a nitrogen atom, or a halogen atom, each of R₁, R₂, R₃, R₄, and R₅ may be different or the same, 1≥z≥50,000, and 1≥y≥50,000.

### Example 22

The composition of Example 21, wherein each of R₂, R₃, R₄, and R₅ comprises at least one of a hydroxyl group, an alkyl group, an alkoxy group, a carboxylic acid, or an ether.

### Example 23

The composition of Example 21, wherein the composition is derived from a dimer comprising at least one of

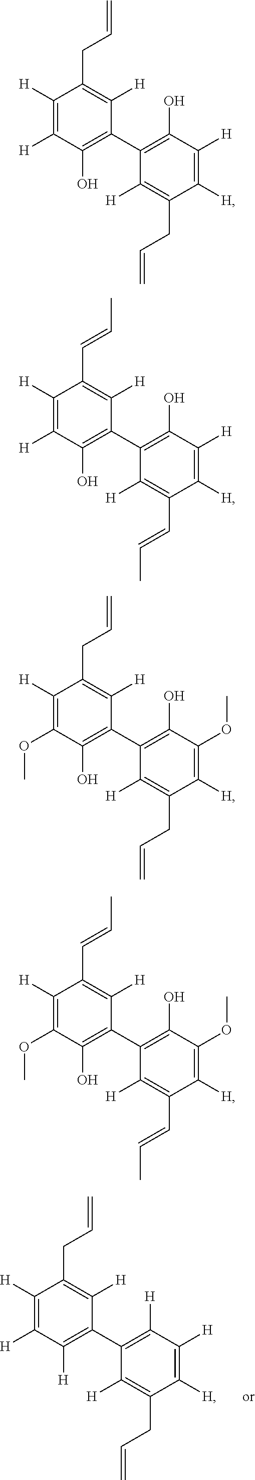

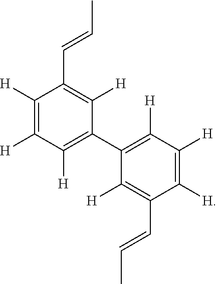

### Example 24

The composition of Example 21, wherein the composition comprises at least one of

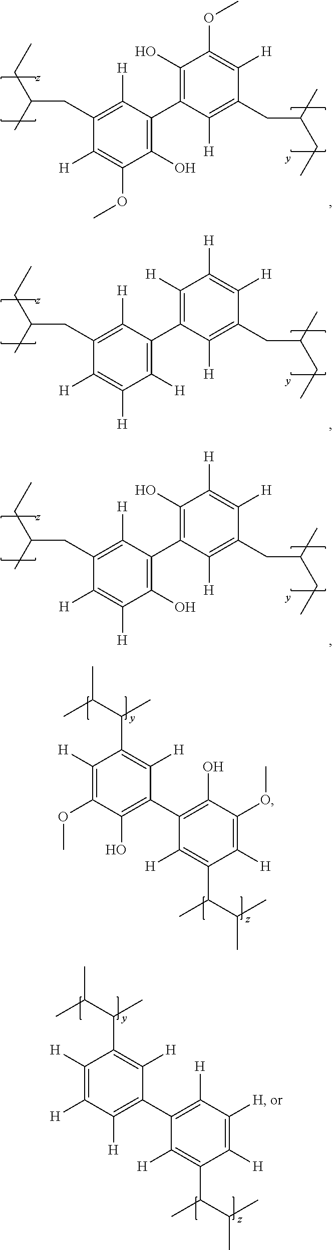

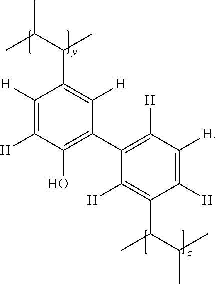

### Example 25

The composition of Example 21, wherein the composition is at least partially bioderived.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A composition comprising:
at least one of 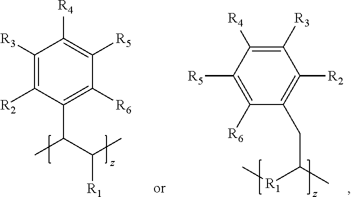
wherein:
each of R₁, R₂, R₃, R₄, R₅, and R₆ comprises at least one of a carbon atom, a hydrogen atom, an oxygen atom, a nitrogen atom, or a halogen atom,
each of R₁, R₂, R₃, R₄, R₅, and R₆ may be different or the same, and
1≥z≥50,000.

2. The composition of claim 1, wherein each of R₁, R₂, R₃, R₄, R₅, and R₆ comprises at least one of a hydroxyl group, an alkyl group, an alkoxy group, a carboxylic acid, or an ether.

3. The composition of claim 1, wherein the composition is derived from a monomer comprising at least one of

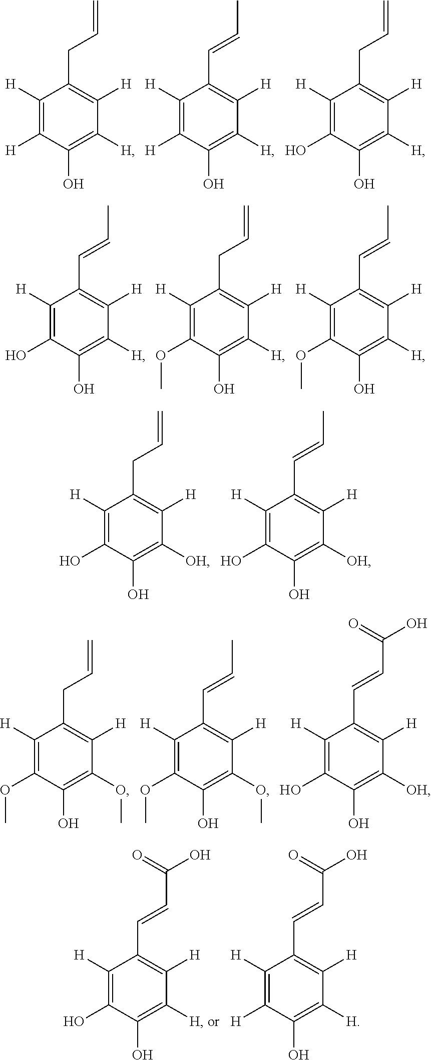

4. The composition of claim 1, comprising at least one of

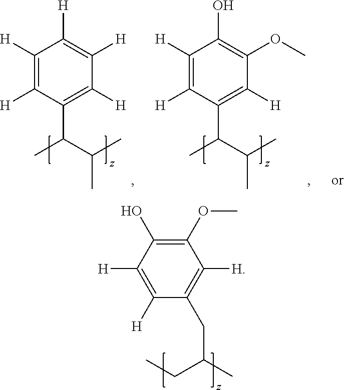

5. The composition of claim 1, further comprising a repeat unit, A, resulting in 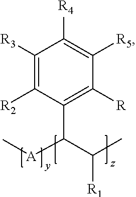
wherein A comprises at least one of a carbon atom, a hydrogen atom, an oxygen atom, or a nitrogen atom, and 1≥y≥50,000.

6. The composition of claim 5, comprising at least one of

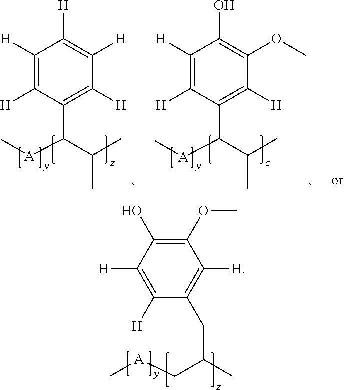

7. The composition of 6, comprising at least one of

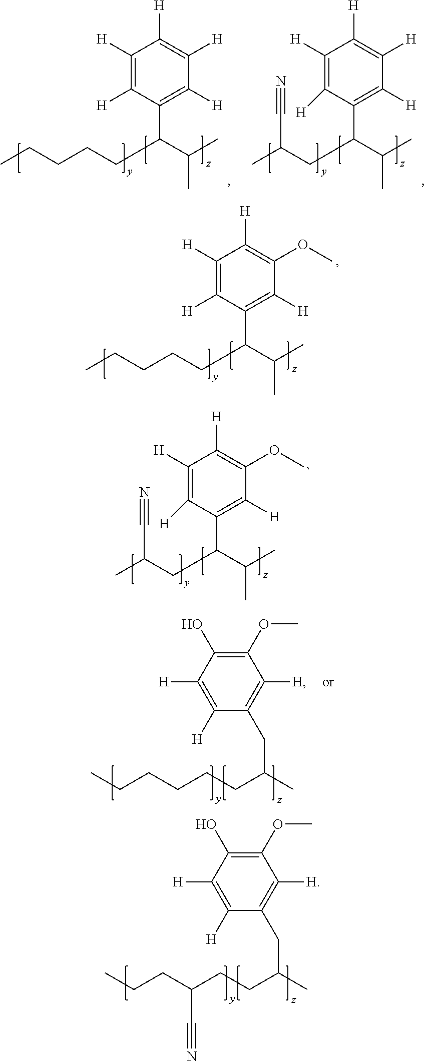

8. The composition of claim 7, further comprising at least one of 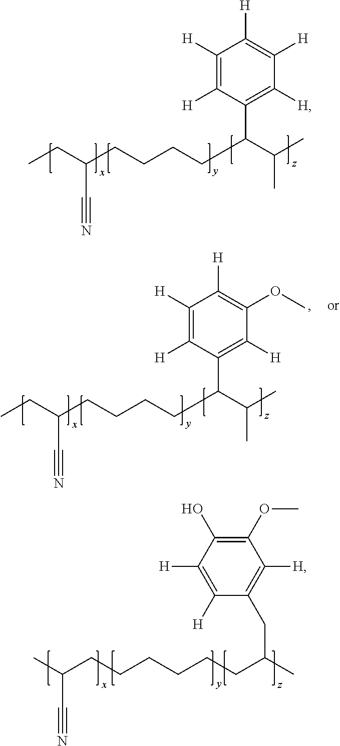
wherein 1≥x≥50,000.

9. The composition of claim 8, further comprising a storage modulus between greater than about 100 GPa and less than about 1000 GPa.

10. The composition of claim 8, further comprising a loss modulus between greater than about 10 Pa and less than about 110 Pa.

11. The composition of claim 8, further comprising a glass transition temperature between greater than about 100° C. and less than about 130° C.

12. The composition of claim 1, wherein the composition is at least partially bioderived.

13. A method of making a polymer, the method comprising:
recovering a monomer from a lignin-containing material; and
reacting the monomer to produce a polymer comprising:
at least one of 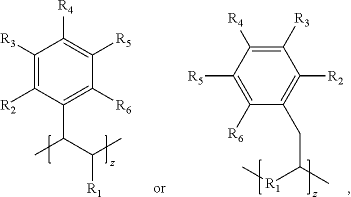
wherein:
each of R₁, R₂, R₃, R₄, R₅, and R₆ comprises at least one of a carbon atom, a hydrogen atom, an oxygen atom, a nitrogen atom, or a halogen atom,
each of R₁, R₂, R₃, R₄, R₅, and R₆ may be different or the same, and
1≥z≥50,000.

14. A composition comprising:
at least one of 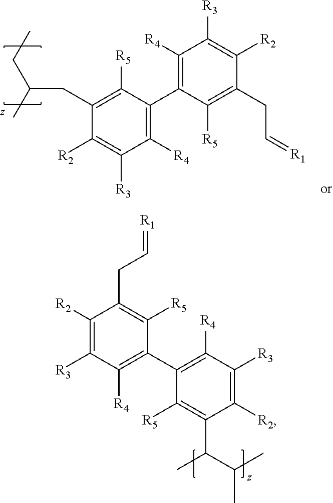
wherein:
each of R₁, R₂, R₃, R₄, and R₅ comprises at least one of a carbon atom, a hydrogen atom, an oxygen atom, a nitrogen atom, or a halogen atom,
each of R₁, R₂, R₃, R₄, and R₅ may be different or the same, and
1≥z≥50,000.

15. The composition of claim 14, wherein the composition is derived from a dimer comprising at least one of

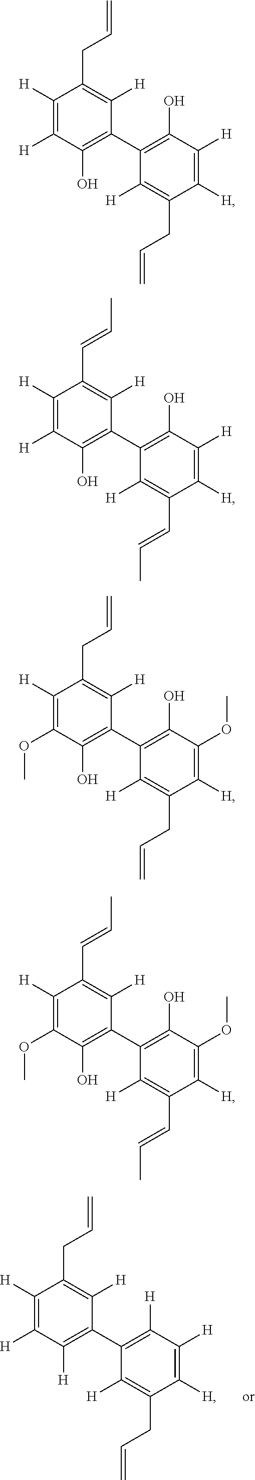

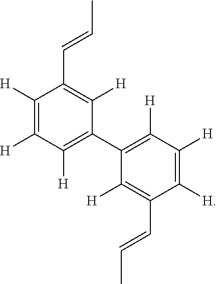

16. The composition of claim 14, comprising at least one of

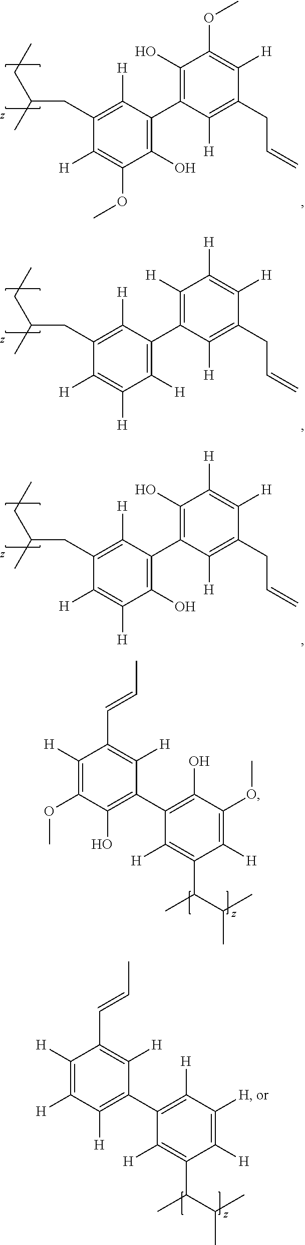

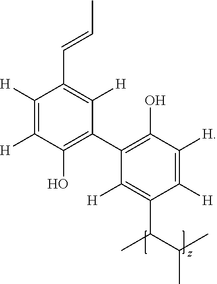

17. The composition of claim 14, wherein the composition is at least partially bioderived.

18. A composition comprising:
at least one of 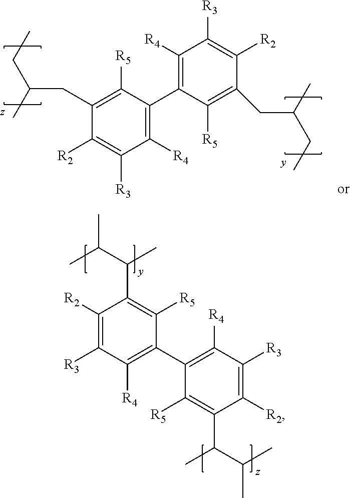
wherein:
each of R₂, R₃, R₄, and R₅ comprises at least one of a carbon atom, a hydrogen atom, an oxygen atom, a nitrogen atom, or a halogen atom,
each of R₁, R₂, R₃, R₄, and R₅ may be different or the same,
1≥z≥50,000, and
1≥y≥50,000.

19. The composition of claim 18, wherein the composition is derived from a dimer comprising at least one of

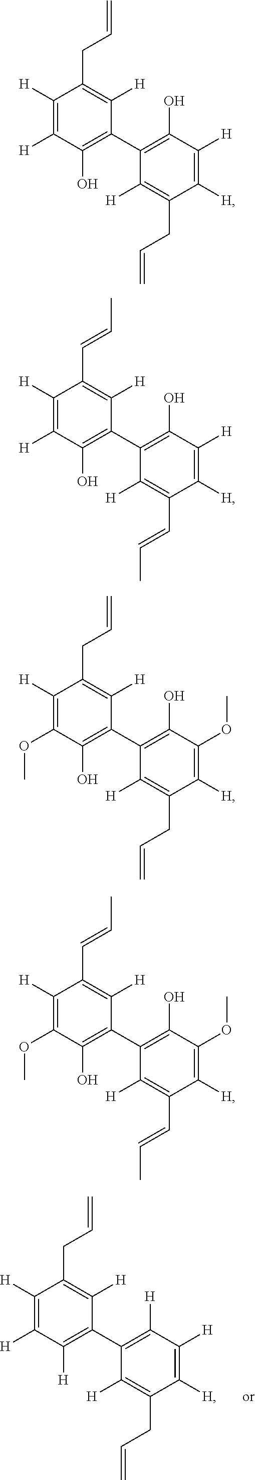

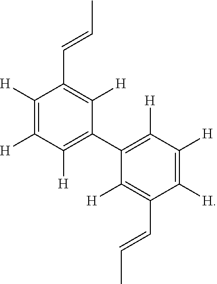

20. The composition of claim 18, wherein the composition comprises at least one of 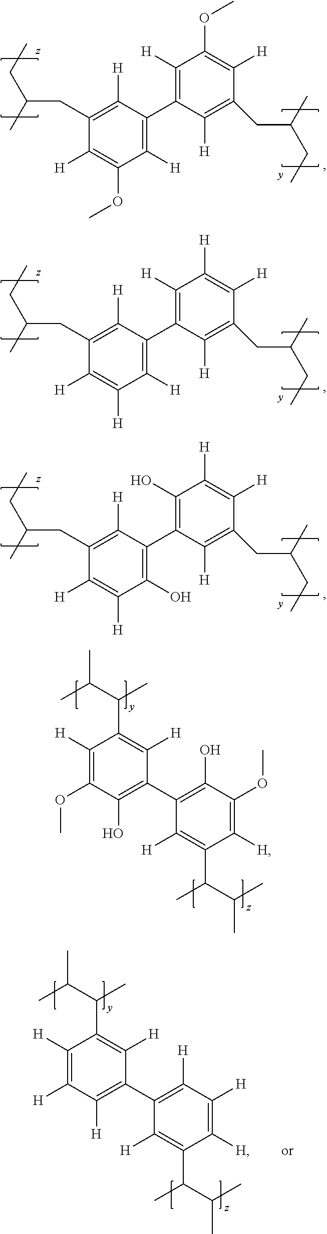 [chemical structure]
